(19) United States
(12) Patent Application Publication
(10) Pub. No.: US 2017/0151943 A1
(43) Pub. Date: Jun. 1, 2017

(54) METHOD, APPARATUS, AND COMPUTER PROGRAM PRODUCT FOR OBTAINING OBJECT

(71) Applicant: DENSO CORPORATION, Kariya-city, Aichi-pref. (JP)

(72) Inventor: Kunihiro Goto, Kariya-city, Aichi-pref. (JP)

(21) Appl. No.: 15/322,815

(22) PCT Filed: Jul. 2, 2015
(86) PCT No.: PCT/JP2015/069187

§ 371 Date: Dec. 29, 2016

(30) Foreign Application Priority Data
Jul. 2, 2014 (JP) 2014-137006

(51) Int. Cl. B60W 30/09; G06K 9/00; B60W 10/184; G05D 1/02; G08G 1/16; B60W 10/20

(52) U.S. Cl. CPC B60W 30/09; G08G 1/16; B60W 10/20; B60W 10/184; G05D 1/0246; G06K 9/00805; B60W 2550/10; B60W 2710/20; B60W 2710/18; B60W 2420/42; G05D 2201/0213

(57) ABSTRACT

A state transition unit of an object detection apparatus determines which of plural states that information about at least one object lies in based on a predetermined state transition condition each time the information about the at least one object candidate is obtained, the plural states being previously defined based on correlations of the at least one object candidate with the target object. The state transition unit causes the information about the at least one object candidate to transition among the plural states. A determiner determines whether the at least one object candidate is a target object based on transition information, the transition information representing how a state associated with the at least one object candidate has previously transitioned.

### TECHNICAL FIELD

The present invention relates to apparatuses and computer program products for obtaining target objects around a vehicle.

### BACKGROUND ART

Various apparatuses for detecting target objects, such as pedestrians, around a vehicle have been proposed. For example, there is an apparatus disclosed in patent document 1 as an example of apparatuses for performing such a detection method. The apparatus obtains an index representing the detectability of the shape of a target object. The apparatus sets a threshold, which is to determine whether a detected object around a vehicle is the target object, to be a lower value as the index decreases, i.e. detection of the shape of the target object becomes more difficult. This aims to improve the detection rate of the target objects.

### CITATION LIST

### Patent Document

[Patent Document 1] Japanese Patent Publication No. 4937029

### SUMMARY

The apparatus disclosed in patent document 1 determines whether a detected object around a vehicle is a target object using the threshold. Setting the threshold to be a lower value makes it easier to determine that an object detected around a vehicle is a target object even though there is a a low level of reliability that the detected object is determined as the target object. This may increase false detections where an object, which is not a target object, is detected as a target object.

An aspect of the present disclosure provides methods, apparatuses, and computer program products for detecting an object, which are capable of addressing such a problem. Specifically, another aspect of the present disclosure aims to provide methods, apparatuses, and computer program products for detecting an object, which are capable of detecting target objects around an own vehicle with higher accuracy.

### Means for Solving Problem

An object detection apparatus according to a first aspect of the present invention is to detect a specified type of objects around a vehicle as a target object. The object detection apparatus includes an obtaining unit configured to repeatedly obtain information based on at least a location of at least one object candidate around the vehicle. The at least one object candidate is a candidate for the target object. The object detection apparatus includes a state transition unit configured to determine which of plural states that the information about the at least one object lies in based on a predetermined state transition condition each time the information about the at least one object candidate is obtained. The plural states are previously defined based on correlations of the at least one object candidate with the target object. The state transition unit is configured to cause the information about the at least one object candidate to transition among the plural states. The object detection apparatus includes a determiner configured to determine whether the at least one object candidate is a target object based on transition information. The transition information represents how a state associated with the at least one object candidate has previously transited.

A computer program product according to a second aspect of the present invention is to detect is a computer program product readable by a computer for detecting a specified type of objects around a vehicle as a target object. The computer program product is configured to cause a computer to execute
(1) A first step of repeatedly obtaining information based on at least a location of at least one object candidate around the vehicle, the at least one object candidate being a candidate of the target object
(2) A second step of
   (a) Determining which of plural states that the information about the at least one object lies in based on a predetermined state transition condition each time the information about the at least one object candidate is obtained, the plural states being previously defined based on correlations of the at least one object candidate with the target object
   (b) Causing the information about the at least one object candidate to transition among the plural states; and
(3) A third step of determining whether the at least one object candidate is a target object based on transition information, the transition information representing how a state associated with the at least one object candidate has previously transited.

A method of detecting a specified type of objects around a vehicle as a target object includes
(1) A first step of repeatedly obtaining information based on at least a location of at least one object candidate around the vehicle, the at least one object candidate being a candidate of the target object
(2) A second step of
   (a) Determining which of plural states that the information about the at least one object lies in based on a predetermined state transition condition each time the information about the at least one object candidate is obtained, the plural states being previously defined based on correlations of the at least one object candidate with the target object
   (b) Causing the information about the at least one object candidate to transition among the plural states
(3) A third step of determining whether the at least one object candidate is a target object based on transition information, the transition information representing how a state associated with the at least one object candidate has previously transitioned.

Each of the first to third aspects of the present invention is configured to determine whether the at least one object candidate is a target object based on transition information. The transition information represents how the state associated with the at least one object candidate has been transited among the plural states, and the plural states are previously defined based on correlations of the at least one object candidate with the target object.

Each of the first to third aspects therefore enables target objects to be detected with higher accuracy as compared to the conventional structure that determines whether a detected object is a target object using a simple threshold.

### BRIEF DESCRIPTION OF DRAWINGS

FIG. 1 is a block diagram illustrating a schematic structure of an object detection apparatus according to a present embodiment of the present invention;

FIG. 2 is a flowchart illustrating an example of a target-object detection routine carried out a CPU of a processor illustrated in FIG. 1;

FIG. 3 is a diagram illustrating an example of pedestrian-candidate rectangular regions in a frame image captured by a camera illustrated in FIG. 1;

FIG. 4 is a diagram for describing a first identifier assigned to each of four pedestrian-candidate rectangular regions grouped as a cluster rectangular region and to the cluster rectangular region;

FIG. 5 is a diagram for describing a second identifier assigned to each of four pedestrian-candidate rectangular regions grouped as a cluster rectangular region and to the cluster rectangular region;

FIG. 6 is a diagram for describing a third identifier assigned to each of four pedestrian-candidate rectangular regions grouped as a cluster rectangular region and to the cluster rectangular region;

FIG. 7 is a diagram for describing a fourth identifier assigned to each of four pedestrian-candidate rectangular regions grouped as a cluster rectangular region and to the cluster rectangular region;

FIG. 8 is a diagram illustrating an example of cluster rectangular regions obtained by the target-object detection routine;

FIG. 9 is a table illustrating an example of conditions required for a tracking-target cluster lying in a tracking state to transit to another tracking state;

FIG. 10 is a diagram illustrating an example of state transition among the tracking states;

FIG. 11 is a diagram illustrating an example of plural cluster rectangular regions that are each determined as a tracking target;

FIG. 12 is a table illustrating how the tracking state of one target cluster rectangular region in the plural cluster rectangular regions illustrated in FIG. 11 changes over time in a case where no rushing-out information is detected in the target cluster rectangular region;

FIG. 13 is a diagram illustrating an example of plural cluster rectangular regions that are each determined as tracking target while rushing-out information is detected in the target cluster rectangular region; and

FIG. 14 is a table illustrating how the tracking state of the target cluster rectangular region illustrated in FIG. 13 changes over time while the rushing-out information is detected in the target cluster rectangular region.

### DESCRIPTION OF EMBODIMENTS

The following describes an embodiment of the present invention with reference to the accompanying drawings.

### Structure of Embodiment

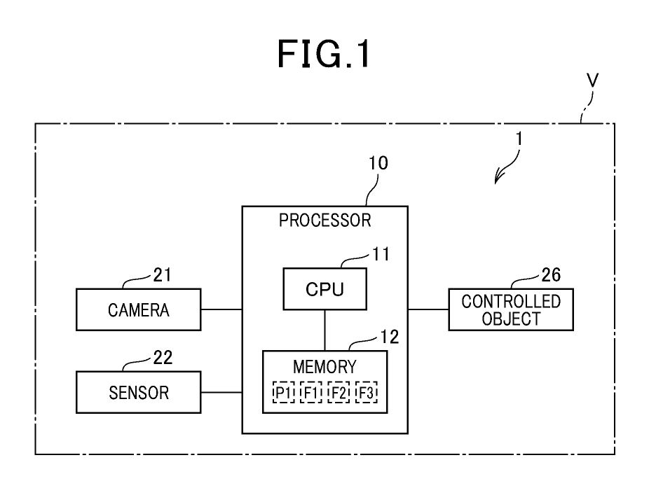

An object detection apparatus 1 according to the present embodiment of the present invention is installed in, for example, a vehicle V, such as a passenger vehicle. The object detection apparatus 1 is operative to detect a specified type of objects, such as pedestrians around the vehicle V as target objects. Referring to FIG. 1, the object detection apparatus 1 includes a processor 10, a camera 21, which for example serves as an image capturing unit, a plurality of sensors 22, and at least one controlled object 26. The camera 21 and at least one controlled object 26 are communicably connected to the processor 10.

The camera 21 is capable of capturing images of, for example, a predetermined detection area established along the travelling direction of the vehicle V; the predetermined detection area is at least a part of the surrounding of the vehicle V. The camera 21 according to the present embodiment is capable of capturing images of a range including the front area of a road on which the vehicle V is travelling, and predetermined areas located at both sides of the front area. The camera 21 is designed as a common camera that captures frame images of the detection area at a predetermined cycle, i.e. at a predetermined frame rate of 30 frames per second (fps). The camera 21 cyclically sends a captured frame image to the processor 10.

The sensors 22 include a known sensor for measuring information indicative of the position and speed of the vehicle V. The sensors 22 also include a known sensor for measuring information indicative of the positions and speeds of the respective objects, such as the relative speeds of the respective objects relative to the vehicle V; the objects include preceding vehicles, and pedestrians.

When information indicative of a target object is received from the processor 10, the at least one controlled object 26 performs, if need arises, an operation to avoid a collision between the target object and the vehicle V, or an operation to reduce impacts based on a collision therebetween. For example, the controlled object 26 includes first and second actuators. The first actuator operates the brake of the vehicle V, and the second actuator operates the steering of the vehicle V. Each of the first and second actuators operates a corresponding one of the brake and the steering of the vehicle V, thus avoiding a collision between the vehicle V and a target object. If a collision between the vehicle V and a target object were to occur, each of the first and second actuators should reduce impacts based on the collision.

The processor 10 is configured as, for example, a computer circuit. The processor 10 includes a CPU 11, and a memory 12 including, for example, a ROM and a RAM. The memory 12 includes a non-transitory storage medium readable by the CPU 11. The CPU 11 executes various tasks, such as a target-object detection task described later, in accordance with programs, i.e. program instructions, stored in the memory 12.

### Operations of Embodiment

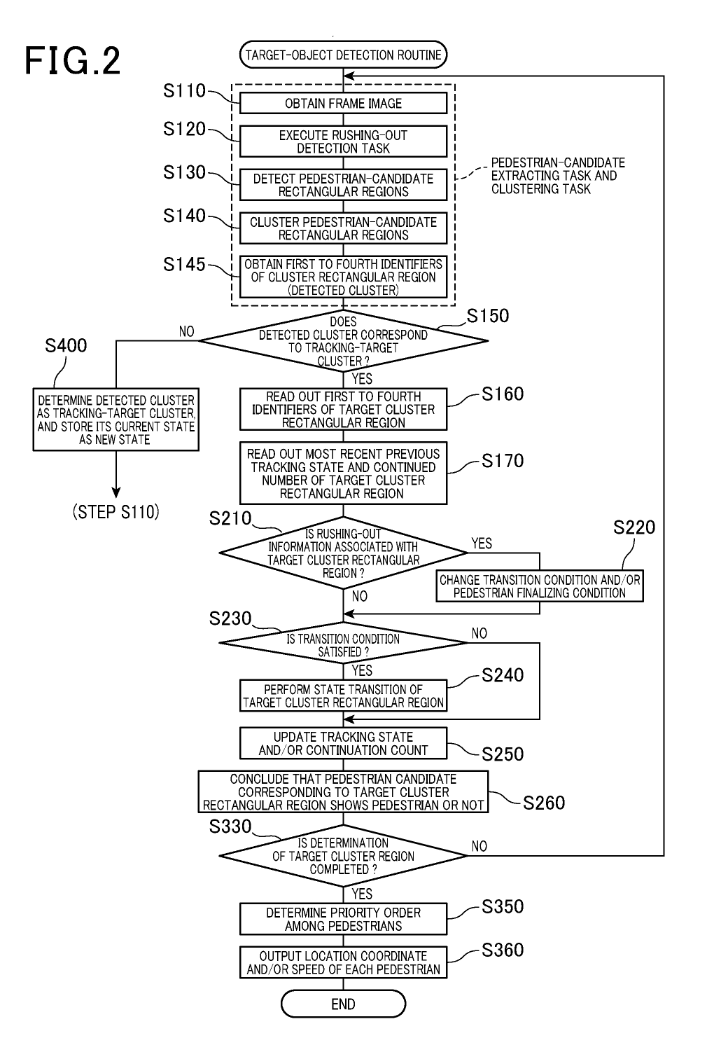

The processor 10 of the above-configured object detection apparatus 1 performs a target-object detection routine illustrated in FIG. 2. The target-object detection routine detects a target object from a frame image captured by the camera 21, and determines whether there is a risk that the vehicle V will collide with the detected target object. The target-object detection routine operates the controlled object 26 upon determining that there is a risk that the vehicle V will collide with the detected target object.

Note that the present embodiment will describe the target-object detection routine for detecting a pedestrian as a target object. The target-object detection task according to the present embodiment is started when the vehicle V is powered on, and thereafter is repeatedly carried out.

When starting the target-object detection routine illustrated in FIG. 2, the processor 10 executes a pedestrian candidate extracting task and a clustering task (see steps S110 to S140). As the information obtaining task, the processor 10 obtains frame images, which are cyclically captured by the camera 21 and cyclically sent from the camera 21 in step S110. Next, the processor 10 executes a rushing-out detection task based on a currently obtained frame image and at least one frame image obtained previous to the currently obtained frame image in step S120.

As the rushing-out detection method, the processor 10 for example uses a method described in Japanese Patent Application Publication No. 2014-029604. Specifically, the processor 10 uses the currently obtained frame image, which is for example expressed by Iₙ, and at least one frame image, which is for example expressed by Iₙ₋₁, Iₙ₋₂, . . . , obtained previous to the currently obtained frame image to extract feature points, which correspond to each other, in the frame images Iₙ, Iₙ₋₁, . . . Then, the processor 10 calculates an optical flow of each of the extracted feature points. The processor 10 determines, based on the calculated optical flows, whether there is at least one object that has a rushing-out probability higher than a predetermined value. The rushing-out probability represents a probability that the at least one object will rush out into a predicted travelling region of the vehicle V, for example, the front of the travelling lane of the travelling road. Note that the predicted travelling region of the vehicle V can be estimated based on the currently captured frame image.

For example, the processor 10 obtains angles of objects, which are based on the optical flows, entering into the predicted travelling region of the vehicle V. Then, the processor 10 obtains, based on each of the angles, a probability that the corresponding one of the objects rushes out into the predicted travelling region of the vehicle V.

When it is determined that there is at least one object that has the rushing-out probability higher than the predetermined value, the processor 10 determines that the at least one object is a rushing-out object in the coordinate space defined based on the space of the currently obtained frame image. Then, the processor 10 stores, in the memory 12, the coordinate location of the at least one rushing-out object to correlate with identification information of the at least one rushing-out object. Note that the coordinate location of the at least one rushing-out object can include the coordinates of a rectangular region enclosing the at least one rushing-out object, or include the coordinate of a single representative feature point of the at least one rushing-out object.

Note that the processor 10 can identify types of objects in the frame images Iₙ, Iₙ₋₁, Iₙ₋₂, . . . using a known pattern recognition task, and execute rushing-out determination for each of the identified types of objects using optical flows. As compared to this modification, the rushing-out detection task used in step S120 is capable of determining whether there is at least one object that will rush out without identifying the type of the at least one object. The rushing-out detection task used in step S120 has therefore the advantage of being performed faster and more simply.

Next, the processor 10 detects, from the currently obtained frame image, i.e. the frame image presently sent from the camera 21, candidates of the target object, i.e. objects appearing as pedestrians in step S130.

The operation in step S130 detects, from the currently obtained frame image, many rectangular regions each enclosing a candidate of pedestrians as the target object using a previously prepared detection method. The rectangular regions will be referred to as pedestrian-candidate rectangular regions.

Then, the processor 10 associates, in the large number of pedestrian-candidate rectangular regions, pedestrian-candidate rectangular regions, which have similar positions and/or sizes, with each other, thus grouping, i.e. clustering, the associated pedestrian-candidate rectangular regions into a typical cluster rectangular region in step S140.

Note that pixel patterns, i.e. feature patterns, respectively representing pedestrians in each frame image, have been learned from a large number of frame images each including pedestrians as the target object according to the present embodiment. The learned patterns are stored in the memory 12 as dictionary files.

For example, feature patterns respectively representing the whole bodies, which include upper and lower bodies, of pedestrians, are stored in the memory 12 as a dictionary file F1 according to the present embodiment.

In addition, feature patterns respectively representing the upper bodies of pedestrians are stored in the memory 12 as a dictionary file F2 according to the present embodiment. Moreover, feature patterns respectively representing the lower bodies of pedestrians are stored in the memory 12 as a dictionary file F3 according to the present embodiment.

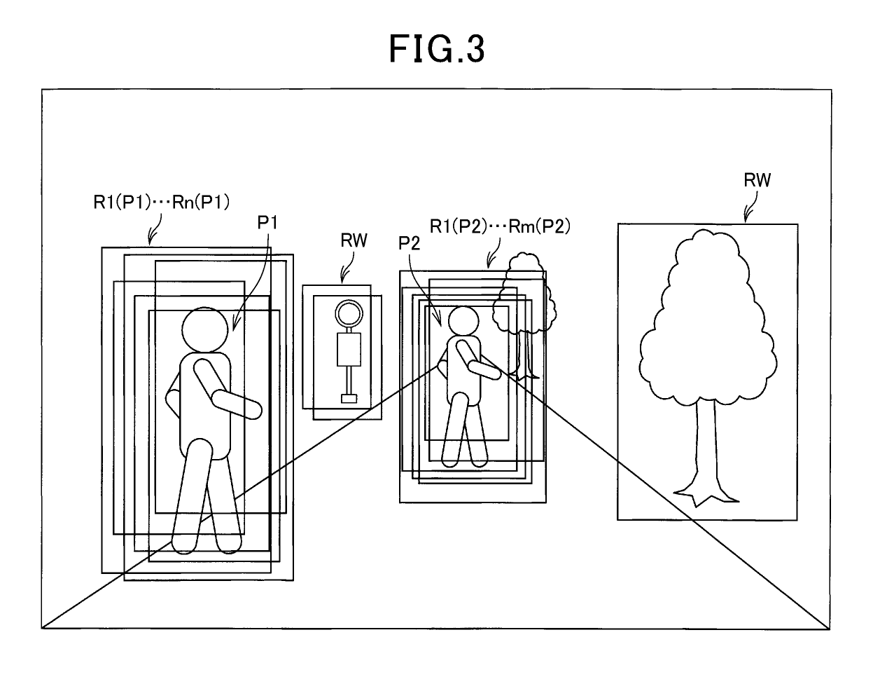

The present embodiment prepares beforehand the first to fourth detection methods. These methods of the present embodiment use at least one of the dictionary files F1 to F3 to detect one or more pedestrian-candidate rectangular regions from the currently obtained frame image. For this reason, the number of pedestrian-candidate rectangular regions R1(P1) to Rn(P1) detected for an actual pedestrian P1 and the number of pedestrian-candidate rectangular regions R1(P2) to Rm(P2) detected for an actual pedestrian P2 are larger than the number of pedestrian-candidate rectangular regions RW erroneously detected for each of a tree or a traffic sign (see FIG. 3).

Note that reliability levels of pedestrian detection are set for the respective dictionary files F1 to F3. For example, the dictionary file F1 has the highest reliability level, the dictionary file F2 has the second highest reliability level, and the dictionary file F3 has the third highest reliability level. That is, a rectangular region obtained based on the dictionary file F1 has the reliability level of corresponding to a pedestrian higher than a rectangular region obtained based on the dictionary file F2.

The detection method according to the present embodiment obtains cluster rectangular regions from many pedestrian-candidate rectangular regions, and thereafter assigns different pieces of identification information, i.e. identifiers, to the respective cluster rectangular regions. Specifically, the detection method includes the following first to eighth steps.

The first step scans, i.e. searches, the currently obtained frame image using a rectangular detecting window, i.e. a rectangular searching window, having a predetermined size. Note that the present embodiment can use plural searching methods for scanning, i.e. searching, the currently obtained frame image.

For example, the present embodiment can use the first to third searching methods SM1 to SM3 as an example.

The first searching method SM1 uses pedestrian-candidate rectangular regions, which were obtained in a previous frame image obtained previous to the currently obtained frame image, such as the last frame image obtained immediately before the currently obtained frame image. Then, the first searching method SM1 shifts the rectangular detecting window on each area, which includes a corresponding one of the pedestrian-candidate rectangular regions and its surrounding, of the currently obtained frame image by predetermined pixels, thus scanning the currently obtained frame image. The first searching method SM1 also obtains a pixel pattern (the pattern of pixels) in the rectangular detecting window of each scanned position, that is, a feature pattern of the image in the rectangular detecting window of each scanned position.

The second searching method SM2 is used if the rushing-out information is detected in a previous frame image obtained previous to the currently obtained frame image, such as the last frame image obtained immediately before the currently obtained frame image.

That is, the second searching method SM2 is configured to
(1) Shift the rectangular detecting window on the area, which includes the location corresponding to the detected rushing-out information and its surrounding, of the currently obtained frame image by predetermined pixels, thus scanning the currently obtained frame image
(2) Obtain a pixel pattern (the pattern of pixels) in the rectangular detecting window of each scanned position, that is, a feature pattern of the image in the rectangular detecting window of each scanned position.

The third searching method SM3 scans the rectangular detecting window on the currently obtained frame image from the upper left corner, which is the initial scan position, to the lower right corner while alternately shifting the rectangular detecting window in the horizontal direction by predetermined pixels and in the vertical direction by predetermined pixels. Then, the third searching method SM3 obtain a pixel pattern (the pattern of pixels) in the rectangular detecting window of each scanned position, that is, a feature pattern of the image in the rectangular detecting window of each scanned position.

Reliability levels of pedestrian detection are set for the respective first to third searching methods SM1 to SM3. For example, the first searching method SM1 has the highest reliability level, the second searching method SM2 has the second highest reliability level, and the third searching method SM3 has the third highest reliability level. That is, a rectangular region obtained based on the first searching method SM1 has the reliability level of corresponding to a pedestrian higher than a rectangular region obtained based on the second searching method SM2.

The second step obtains similarities between each of the feature patterns obtained at the respective scanned positions of the rectangular detecting window and many feature patterns included in at least one dictionary file in the dictionary files F1 to F3. The similarities are also referred to as scores.

For example, if the rectangular detecting window whose size encloses the whole body of pedestrians is used, the second step for example obtains the similarities using the dictionary file F1. If the rectangular detecting window whose size encloses the upper body of pedestrians is used, the fourth step for example obtains the similarities using the dictionary file F2.

The third step determines that rectangular detecting windows of the respective scanned positions, which have respective similarities obtained in step S2 higher than a predetermined first threshold value, as pedestrian-candidate rectangular regions.

Note that each of the first to third steps, which correspond to step S130, uses the rectangular detecting window having a predetermined size, but the detection method according to the present embodiment is not limited thereto. Specifically, the detection method according to the present embodiment can use rectangular detecting windows respectively having different sizes. The detection method according to this modification of the present embodiment performs the first to third steps for each of the different-sized rectangular detecting windows, thus detecting many rectangular detecting windows as the pedestrian-candidate rectangular regions.

Next, the detection method performs the fourth step to
(1) Associate, in the large number of pedestrian-candidate rectangular regions obtained in step S3, plural groups (clusters) of pedestrian-candidate rectangular regions; the pedestrian-candidate rectangular regions of each group have similar positions and/or sizes with each other
(2) Select, as a typical cluster rectangular region, one of the pedestrian-candidate rectangular regions of each cluster.

This results in the large number of pedestrian-candidate rectangular regions being categorized into the typical cluster rectangular regions in step S140.

Then, the detection method performs the fifth step to assign, for each cluster rectangular region, the number of pedestrian-candidate rectangular regions associated with the corresponding cluster rectangular region as a first identifier, i.e. likelihood-relevant information in step S145.

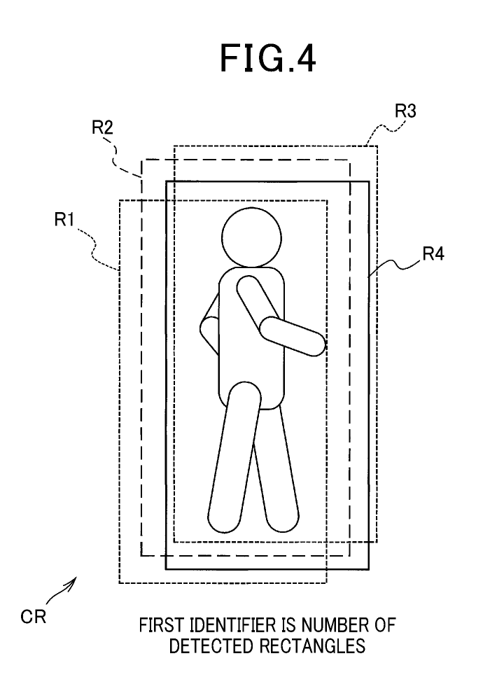

For example, FIG. 4 illustrates four pedestrian-candidate rectangular regions R1 to R4, which are grouped into a cluster rectangular region CR. Specifically, the number of rectangular detecting regions, i.e. 4, is assigned to the cluster rectangular region CR as the first identifier.

Next, the detection method performs, in step S145, the sixth step to
(1) Obtain the maximum value and average value of the similarities, i.e. scores, of pedestrian-candidate rectangular regions associated with each cluster rectangular region as a maximum score and an average score
(2) Assign, to the corresponding cluster rectangular region, the maximum score and average score as a second identifier, i.e. likelihood-relevant information. Note that the present embodiment uses the average score as the second identifier.

Note that a rectangular region, which has a higher score, means that the reliability level of an actually pedestrian being included in the rectangular region is higher.

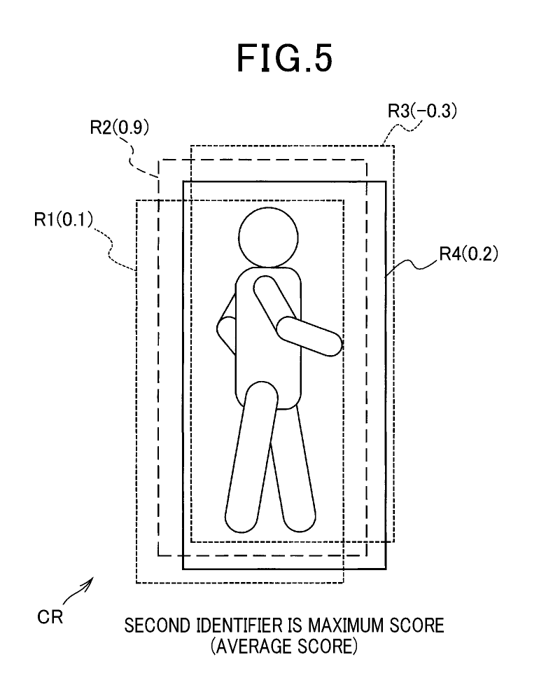

For example, FIG. 5 illustrates four pedestrian-candidate rectangular regions R1 to R4, which are grouped into a cluster rectangular region CR, and the scores (0.9, 0.1, −0.3, 0.3) of the respective pedestrian-candidate rectangular regions R1 to R4. Specifically, the maximum score 0.9 and the average score 0.225 are assigned to the cluster rectangular region CR as the second identifier.

Subsequently, the detection method performs, in step S145, the seventh step to assign, to each cluster rectangular region, one of the dictionary files used for obtaining the similarities of pedestrian-candidate rectangular regions associated with the corresponding cluster rectangular region, as a third identifier, i.e. likelihood-relevant information; one of the dictionary files has the highest reliability level in them.

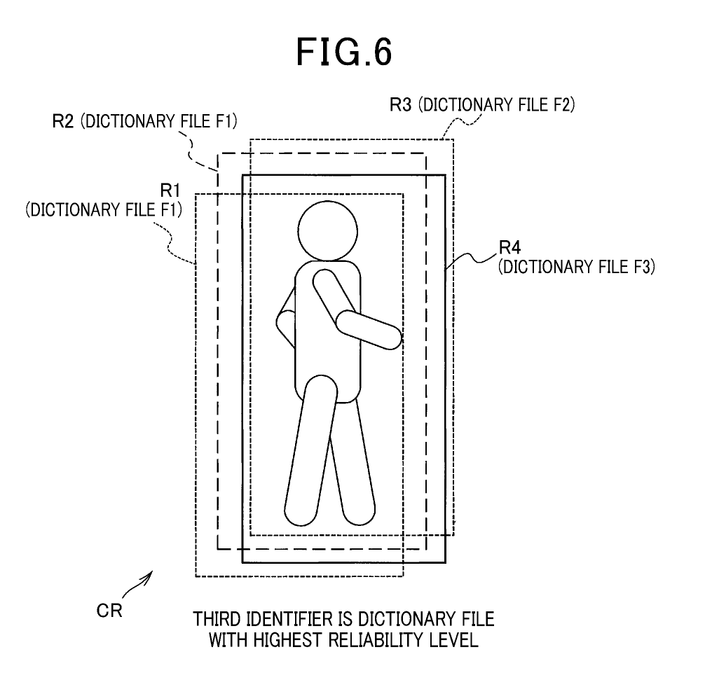

For example, FIG. 6 illustrates four pedestrian-candidate rectangular regions R1 to R4, which are grouped into a cluster rectangular region CR, and the dictionary files (F1, F1, F2, F3) corresponding to the respective pedestrian-candidate rectangular regions R1 to R4. Specifically, the dictionary file Fl having the maximum reliability level is assigned to the cluster rectangular region CR as the third identifier.

In addition, the detection method performs, in step S145, the eight step to assign, to each cluster rectangular region, one of the searching methods used for obtaining pedestrian-candidate rectangular regions associated with the corresponding cluster rectangular region, as a fourth identifier, i.e. likelihood-relevant information; one of the searching methods has the highest reliability level in them.

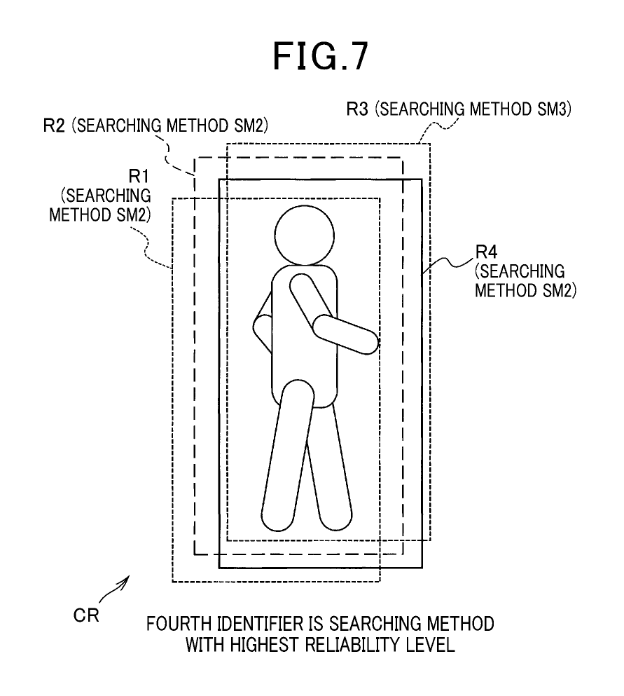

For example, FIG. 7 illustrates four pedestrian-candidate rectangular regions R1 to R4, which are grouped into a cluster rectangular region CR, and the searching methods (SM2, SM2, SM3, SM2) corresponding to the respective pedestrian-candidate rectangular regions R1 to R4. Specifically, the searching method SM2 having the maximum reliability level is assigned to the cluster rectangular region CR as the fourth identifier.

The detection method according to the present embodiment can use known classifiers combined with each other, each of which is capable of calculating the similarities, i.e. scores, when obtaining pedestrian-candidate rectangular frames for each frame image obtained by the camera 21. A known support vector machine (SVM) can be used for each classifier. As feature patterns of the image in a rectangular detecting window, known histograms of oriented edges (HOG), i.e. HOG features, or Haar-like features can be used.

As described above, the processor 10 performs, in step S140, the detection method according to the present embodiment to
1. Associate, in the large number of detected pedestrian-candidate rectangular regions, plural groups (clusters) of pedestrian-candidate rectangular regions; the pedestrian-candidate rectangular regions of each group have similar positions and/or sizes with each other
2. Cluster the grouped pedestrian-candidate rectangular regions into a typical cluster rectangular region.

After determining a cluster rectangular region for each group, the processor 10 stores, in the memory 12, the coordinate location of the cluster rectangular region of each group in the coordinate space such that the coordinate location of the cluster rectangular region of each group correlates with the first to fourth identifiers in step S145; the coordinate space corresponds to the space of the currently obtained frame image.

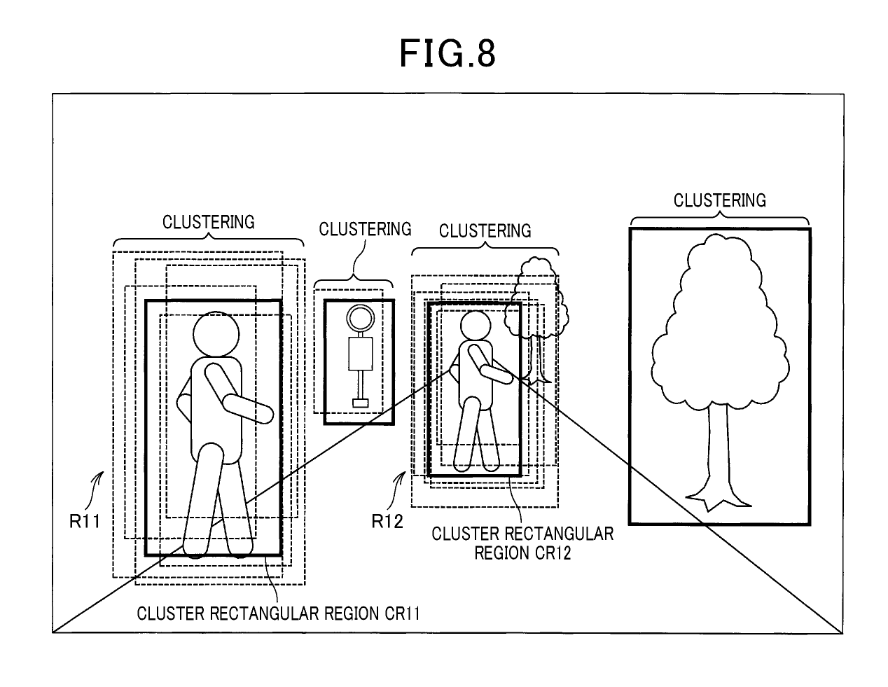

For example, referring to FIG. 8, a group of pedestrian-candidate rectangular regions R11 illustrated in dashed boxes are represented as a single cluster rectangular region CR11 illustrated as a solid box. Similarly, a group of pedestrian-candidate rectangular regions R12 illustrated in dashed boxes are represented as a single cluster rectangular region CR12 illustrated as a solid box.

For example, plural cluster rectangular regions, which are obtained as an example in step S140, are also referred to as detected clusters.

Subsequently, the processor 10 determines, in step S150, whether the detected clusters respectively correspond to, for example, plural cluster rectangular regions that are currently being tracked in step S150; the plural rectangular clusters, which are currently tracked, are also referred to as tracking-target clusters. Specifically, the processor 10 determines whether the coordinate location of each cluster rectangular region detected in step S140 is close to the coordinate location of any one of tracking-target clusters that are currently being tracked in step S150.

Upon determining that the result of the determination is NO (NO in step S150), the processor 10 determines that the plural cluster rectangular regions detected in step S140 are new tracking-target clusters that are to be tracked. After the determination, the current target-object detection routine, i.e. the current target-object detection routine for the currently obtained frame image, proceeds to step S400.

In step S400, the processor 10 sets the current tracking state of each new tracking-target cluster to a new tracking state, and stores, in the memory 12, the new tracking state being associated with the identifier and the coordinate location of the corresponding new tracking-target cluster. Thereafter, the processor 10 returns to step S110, and executes the operations in steps S110 to S330 based on a frame image sent from the camera 21.

Otherwise, upon determining that both of the first and second determination results are YES (YES in step S150), the processor 10 determines that the cluster rectangular regions detected in step S140 correspond to the respective tracking-target clusters that have been tracked by the last, i.e. most recent previous, target-object detection routine, i.e. the target-object detection routine for the most recent previous frame image. After the results of the determination, the current target-object detection routine proceeds to step S160.

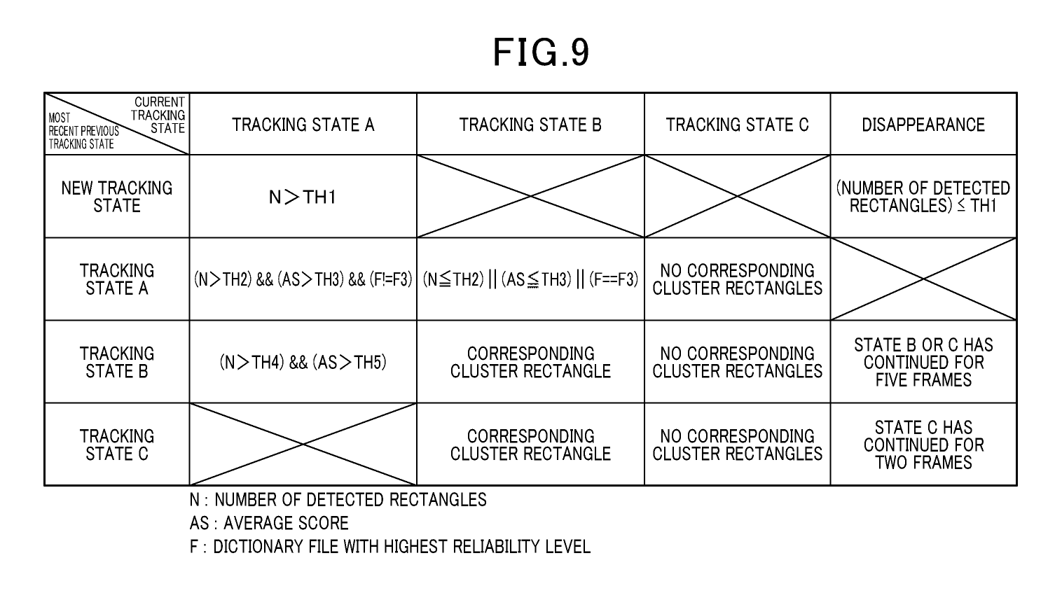

Note that, as illustrated in FIG. 9, the tracking state of a cluster rectangular region includes the three tracking states A, B, and C previously prepared in addition to the initial tracking state. The present embodiment is configured such that conditions that tracking-target clusters lying in the respective tracking states transits to another tracking state are previously established. The conditions are stored in the memory 12 or implemented in the program(s) of the target-object detection routine. Except for the new tracking state, a pedestrian candidate corresponding to a cluster rectangular region, which has the tracking state A, has the highest likelihood of being an actual pedestrian. Next, a pedestrian candidate corresponding to a cluster rectangular region, which has the tracking state B, has a next likelihood of being an actual pedestrian. A pedestrian candidate corresponding to a cluster rectangular region, which has the tracking state C, has a lower likelihood of being an actual pedestrian than the likelihood of a pedestrian candidate corresponding to a cluster rectangular region having the tracking state B.

That is, the likelihood of the tracking state A, the likelihood of the tracking state B, and the likelihood of the tracking state C are arranged in this descending order.

Referring to FIG. 9, it is assumed that the value N of the first identifier, i.e. the number N of detected pedestrian-candidate rectangular regions, of a cluster rectangular region, which has been in the new tracking state in the most recent previous target-object detection routine, becomes higher than a first threshold TH1 in the current target-object detection routine. In this assumption, it is determined that the cluster rectangular region lying in the new tracking state in the most recent previous target-object detection routine transitions to the tracking state A.

Similarly, it is assumed that
(1) The value N of the first identifier of a cluster rectangular region, which has been in the tracking state A in the most recent previous target-object detection routine, becomes higher than a second threshold TH2 in the current target-object detection routine
(2) The value AS, i.e. the average score AS, of the second identifier of the cluster rectangular region, which has been in the tracking state A in the most recent previous target-object detection routine, becomes higher than a third threshold TH1 in the current target-object detection routine
(3) The value F, which represents the dictionary file F having the highest reliability level, of the third identifier of the cluster rectangular region, which has been in the tracking state A in the most recent previous target-object detection routine, is not the dictionary file F3.

In this assumption, it is determined that the cluster rectangular region, which has been in the tracking state A in the latest previous target-object detection routine, lies in the tracking state A, in other words, remains in the tracking state A, in the current target-object detection routine.

Note that, as illustrated in FIG. 9, the assumption can be represented by the following expression using logical operators:
(N>TH2)&&(AS>TH3)&&(F!=F3)

Where the logical operator && represents logical AND, and the logical operator != represents that both sides are not equal to each other.

In addition, it is assumed that
(1) The value N of the first identifier of a cluster rectangular region, which has been in the tracking state A in the most recent previous target-object detection routine, becomes equal to or lower than the second threshold TH2 in the current target-object detection routine or
(2) The value AS of the second identifier of the cluster rectangular region, which has been in the tracking state A in the most recent previous target-object detection routine, becomes equal to or lower than the third threshold TH1 in the current target-object detection routine or
(3) The value F of the third identifier of the cluster rectangular region, which has been in the tracking state A in the most recent previous target-object detection routine, is the dictionary file F3.

In this assumption, it is determined that the cluster rectangular region, which has been in the tracking state A in the most recent previous target-object detection routine, transitions to the tracking state B in the current target-object detection routine.

Note that, as illustrated in FIG. 9, the assumption can be represented by the following expression using logical operators:
(N≦TH2)∥(AS>TH3)∥(F==F3)

Where the logical operator ∥ represents logical OR, and the logical operator == represents that both sides are equal to each other.

In addition, it is assumed that a cluster rectangular region, which has been in the tracking state A in the most recent previous target-object detection routine, is not detected in the current target-object detection routine. At that time, it is determined that the cluster rectangular region, which has been in the tracking state A in the most recent previous target-object detection routine, transitions to the tracking state C.

It is assumed that
(1) The value of the first identifier of a cluster rectangular region, which has been in the tracking state B in the most recent previous target-object detection routine, becomes higher than a fourth threshold TH4 in the current target-object detection routine
(2) The value of the second identifier of the cluster rectangular region, which has been in the tracking state B in the most recent previous target-object detection routine, becomes higher than a fifth threshold TH5.

In this assumption, it is determined that the cluster rectangular region, which has been in the tracking state B in the most recent previous target-object detection routine, transitions to the tracking state A in the current target-object detection routine. Note that the condition that the value of the first identifier is higher than the fourth threshold TH4 and the value of the second identifier is higher than the fifth threshold TH5 is referred to as a tracking-state A transition condition.

It is assumed that a cluster rectangular region, which has been in the tracking state B in the most recent previous target-object detection routine, is detected in the current target-object detection routine, and does not meet the tracking-state A transition condition. At that time, it is determined that the cluster rectangular region, which has been in the tracking state B in the most recent previous target-object detection routine, lies in the tracking state B, in other words, remains in the tracking state B, in the current target-object detection routine.

On the other hand, it is assumed that a cluster rectangular region, which has been in the tracking state B in the most recent previous target-object detection routine, is not detected in the current target-object detection routine. At that time, it is determined that the cluster rectangular region, which has been in the tracking state B in the most recent previous target-object detection routine, transitions to the tracking state C.

It is assumed that a cluster rectangular region, which has been in the tracking state C in the most recent previous target-object detection routine, is detected in the current target-object detection routine. At that time, it is determined that the cluster rectangular region, which has been in the tracking state C in the most recent previous target-object detection routine, transitions to the tracking state B.

On the other hand, it is assumed that a cluster rectangular region, which has been in the tracking state C in the most recent previous target-object detection routine, is not detected in the current target-object detection routine. At that time, it is determined that the cluster rectangular region, which has been in the tracking state C in the most recent previous target-object detection routine, lies in the tracking state C, in other words, remains in the tracking state C, in the current target-object detection routine.

Note that the new tracking state is a specific state to which a cluster rectangular region is set when it is determined in step S140 that the cluster rectangular region is the new tracking-target cluster.

In addition, note that the second threshold TH2 is set to be higher than the first and fourth thresholds TH1 and TH4. The fourth threshold TH4 is set to be higher than the first threshold TH1. The third threshold TH3 is set to be higher than the fifth threshold TH5.

In addition, as illustrated in FIG. 9, each tracking-target cluster lying in a corresponding one of the tracking states is configured to disappear if a corresponding condition is satisfied. That is, tracking of each tracking-target cluster lying in a corresponding one of the tracking states is terminated if a corresponding condition is satisfied.

For example, it is assumed that the value of the first identifier of a cluster rectangular region, which has been in the new tracking state in the most recent previous target-object detection routine, becomes equal to or lower than the first threshold TH1 in the current target-object detection routine. At that time, it is determined that the cluster rectangular region, which has been in the new tracking state in the most recent previous target-object detection routine, disappears.

Moreover, it is assumed that a cluster rectangular region
(1) Has been in the tracking state B or C in each of the past four target-object detection routines for the past four frame images
(2) Has been in the tracking state B in the most recent previous target-object detection routine
(3) Is in the tracking state B or C in the current target-object detection routine.

At that time, it is determined that the cluster rectangular region, which has been in the tracking state B in the most recent previous target-object detection routine, disappears.

In addition, it is assumed that a cluster rectangular region, which has been in the tracking state C in the most recent previous target-object detection routine, remains in the tracking state C in the current target-object detection routine. At that time, it is determined that the cluster rectangular region, which has been in the tracking state C in the most recent previous target-object detection routine, disappears.

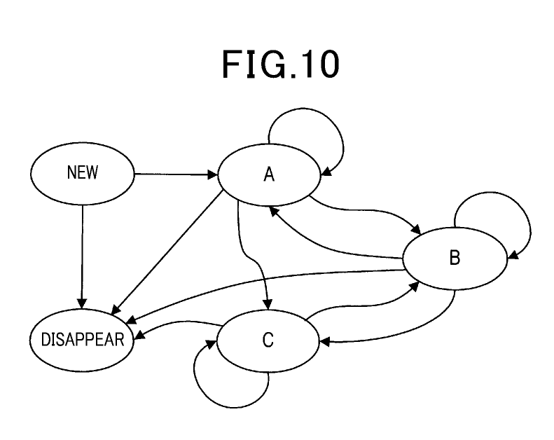

FIG. 10 illustrates an example of a state transition diagram between the above tracking states including the new tracking state, tracking state A, tracking state B, tracking state C, and disappearance.

Note that the present embodiment is configured such that
(1) The transition condition that a tracking-target cluster lying in each tracking state transitions to another tracking state having a higher likelihood is determined to be strict
(2) The transition condition that a tracking-target cluster lying in each tracking state transitions to another tracking state having a lower likelihood is determined to be relaxed.

Additionally, it is assumed that a cluster rectangular region, which has been in the tracking state A in each of the two target-object detection routines for the past two frame images, is determined to be in the tracking state A in the current target-object detection routine.

That is, it is assumed that a cluster rectangular region has been determined to be in the tracking state A for the target-object detection routines continuously for three frame images.

At that time, it is determined that a pedestrian candidate corresponding to the cluster rectangular region, which has been being determined to be in the tracking state A for the target-object detection routines for the continuous three frame images, is finalized as a pedestrian (see step S260 described later). Note that the condition that a cluster rectangular region has been being determined to be in the tracking state A for the target-object detection routines for the continuous three frame images is defined as a pedestrian finalizing condition. That is, the condition that a pedestrian candidate corresponding to the cluster rectangular region, which has been being determined to be in the tracking state A for the target-object detection routines for the continuous three frame images, is finalized as a pedestrian is defined as the pedestrian finalizing condition. The number, i.e. three times, for which a cluster rectangular region has been being determined to be in the target state A is referred to as a number threshold of the target-object detection routine.

A tracking-target cluster lying in each tracking state can transition to another tracking state having a higher likelihood only when the likelihood of the other tracking state is adjacent to the likelihood of the tracking-target cluster. In contrast, a tracking-target cluster lying in each tracking state can transition to any tracking state having a lower likelihood.

For example, if plural cluster rectangular regions are detected in step S140, the processor 10 executes the operations in steps S160 to S330 for each of the detected cluster rectangular regions. The following refers to one of the plural cluster rectangular regions detected in step S140 as a target cluster rectangular region, and describes the operations in steps S160 to S330 for the target cluster rectangular region.

In step S160, the processor 10 reads out the first to fourth identifiers of the target cluster rectangular region from the memory 12. Then, the processor 10 reads out, from the memory 12, the tracking state and the continuation count of the tracking state of a tracking-target cluster corresponding to the target cluster rectangular region in step S170. The tracking state and the continuation count of the tracking state are updated to be stored in the memory 12 in step S250 of the most recent previous target-object detection routine described later.

Subsequently, the processor 10 determines whether the rushing-out information is associated with the target cluster rectangular region in step S210.

Specifically, the processor 10 compares the location coordinate of the target cluster rectangular region with the location coordinates of the rushing-out objects stored in the memory 12. Then, the processor 10 determines whether the location coordinate of the target cluster rectangular region correlates with the location coordinates of the rushing-out objects stored in the memory 12.

Upon determining that the location coordinate of the target cluster rectangular region does not correlate with the location coordinates of the rushing-out objects stored in the memory 12 in accordance with the comparison results (NO in step S210), the target-object detection routine proceeds to step S230 described later.

Otherwise, upon determining that the location coordinate of the target cluster rectangular region correlates with at least one the location coordinates of the rushing-out objects stored in the memory 12 in accordance with the comparison results (YES in step S210), the processor 10 determines that the pedestrian candidate corresponding to the target cluster rectangular region is a rushing-out object. Then, the processor 10 changes the transition condition for transition of the tracking state of the target cluster rectangular region and/or the pedestrian finalizing condition of the target cluster rectangular region in step S220.

For example, when it is determined that the pedestrian candidate corresponding to the target cluster rectangular region is a rushing-out object, the processor 10 changes the transition condition for transition of the tracking state of the target cluster rectangular region and/or the pedestrian finalizing condition of the target cluster rectangular region such that they are relaxed from their current levels in step S220. In other words, when it is determined that the pedestrian candidate corresponding to the target cluster rectangular region is a rushing-out object, the processor 10 changes the transition condition for transition of the tracking state of the target cluster rectangular region and/or the pedestrian finalizing condition of the target cluster rectangular region to increase the probability of the cluster rectangular region being determined as a pedestrian in step S220.

Note that the operation in step S220 is carried out only when the affirmative determination in step S210 is carried out. Specifically, it is assumed that
(1) The affirmative determination in step S210 of the most recent previous target-object detection routine is carried out so that the operation in step S220 is performed to change values of the transition condition for transition of the tracking state of the target cluster rectangular region and/or the pedestrian finalizing condition of the target cluster rectangular region (2) The negative determination in step S210 of the current target-object detection routine is carried out.

In this modification, the transition condition for transition of the tracking state of the target cluster rectangular region and/or the pedestrian finalizing condition of the target cluster rectangular region are returned to their unchanged values.

Subsequently, the processor 10 uses the first to fourth identifiers of the target cluster rectangular region read out in step S160 and the tracking state, i.e. the most recent previous tracking state, of the tracking-target cluster corresponding to the target cluster rectangular region to determine whether at least part of the first to fourth identifiers of the target cluster rectangular region satisfies one of the transition conditions of the most recent previous tracking state in step S230.

For example, as described above, if the most recent previous tracking state is any one of the tracking states A to C, the processor 10 determines whether the first to third identifiers or the first and second identifiers of the target cluster rectangular region satisfy one of the transition conditions corresponding to the most recent previous tracking state (see FIG. 9) in step S230.

Note that the transition conditions for each of the most recent previous tracking states illustrated in FIG. 9 are established based on the first to third identifiers or the first and second identifiers of a target cluster rectangular region, but the present invention is not limited thereto. Specifically, the transition conditions for each of the most recent previous tracking states can be established based on at least one of the first to fourth identifiers. The maximum score can be used as the second identifier.

As described above, if the most recent previous tracking state is the new tracking state, the processor 10 determines whether the first identifier of the target cluster rectangular region satisfies one of the transition conditions corresponding to the most recent previous tracking state (see FIG. 9) in step S230.

When it is determined that at least part of the first to fourth identifiers of the target cluster rectangular region does not satisfy the transition conditions of the most recent previous tracking state (NO in step S230), the target-object detection routine proceeds to step S250 described later. Otherwise, when it is determined that at least part of the first to fourth identifiers of the target cluster rectangular region satisfies one of the transition conditions of the most recent previous tracking state (YES in step S230), the processor 10 changes the current tracking state of the target cluster rectangular region from the previous tracking state to a tracking state corresponding to one of the transition conditions in step S240.

Next, the processor 10 updates the continuation count of the current tracking state of the target cluster rectangular region in step S250. Specifically, the processor 10 updates the continuation count of the tracking state of the target cluster rectangular region stored in the memory 12 by incrementing it by 1 if the current tracking state of the target cluster rectangular region is unchanged from the most recent previous tracking state in step S250.

Otherwise, the processor 10 sets the continuation count of the tracking state of the target cluster rectangular region to 1 to store it in the memory 12 if the current tracking state of the target cluster rectangular region is changed from the most recent previous tracking state in step S250.

The continuation count of the current tracking state of the target cluster rectangular region is a parameter representing a period for which a tracking state of a target cluster rectangular region has continued in a tracking state since the timing when the target cluster rectangular region transitioned to the same tracking state.

Following the operation in step S250, the processor 10 determines whether the pedestrian candidate corresponding to the target cluster rectangular region shows a pedestrian based on whether
(1) The current tracking state of the target cluster rectangular region is the tracking state A
(2) The continuation count of the target cluster rectangular region has reached the number threshold (three times).

When the current tracking state of the target cluster rectangular region is the tracking state A, and the continuation count of the target cluster rectangular region has reached the number threshold, the processor 10 concludes that the pedestrian candidate corresponding to the target cluster rectangular region shows a pedestrian in step S260.

Otherwise, when the current tracking state of the target cluster rectangular region is disappearance, the processor 10 concludes that the pedestrian candidate corresponding to the target cluster rectangular region does not show a pedestrian in step S260.

In addition, the processor 10 concludes that the determination of whether the pedestrian candidate corresponding to the target cluster rectangular region shows a pedestrian is yet unconfirmed when the continuation count of the target cluster rectangular region has not reached the number threshold (three times) although the current tracking state of the target cluster rectangular region is neither disappearance nor the tracking state A or is the tracking state A in step S260.

When the determination in step S260 is completed, the processor 10 determines whether or not the pedestrian candidate corresponding to the target cluster rectangular region is concluded to show a pedestrian or not to show a pedestrian in step S330.

When it is determined that the pedestrian candidate corresponding to the target cluster rectangular region is yet unconcluded to show a pedestrian or not to show a pedestrian (NO in step S330), the processor 10 returns to step S110, and performs the operations in steps S110 to S330 based on a frame image sent from the camera 21.

Otherwise, when it is determined that the pedestrian candidate corresponding to the target cluster rectangular region is concluded to show a pedestrian or not to show a pedestrian (YES in step S330), the target-object detection routine proceeds to step S350.

As described above, if plural cluster rectangular regions are detected in step S140, the processor 10 executes the operations in steps S160 to S330 for each of the detected cluster rectangular regions. Specifically, the processor 10 is configured to
(1) Perform the operation in step S350 when it is determined that the pedestrian candidate corresponding to at least one of the plural target cluster rectangular regions is concluded to show a pedestrian or not to show a pedestrian
(2) Perform the operations in steps S160 to S330 for each of the detected cluster rectangular regions when it is inconclusive whether the pedestrian candidate corresponding to at least one of the plural target cluster rectangular regions shows a pedestrian or not.

In step S350, when it is determined that the pedestrian candidates corresponding to respective target cluster rectangular regions are each concluded to show a pedestrian as a result of the determination in step S330, the processor 10 determines the priority order among the pedestrians in accordance with
1. The location coordinates of the target cluster rectangular regions corresponding to the respective pedestrians stored in the memory 12
2. The rushing-out information of rushing-out object(s) stored in the memory 12
3. The predicted travelling region of the vehicle V stored in the memory 12.

For example, the processor 10 determines the priority order among the pedestrians based on the following first to third conditions:

The first condition is that, if the rushing-out information is associated with a selected one of the target cluster rectangular regions corresponding to the respective pedestrians, the priority order of the pedestrian corresponding to the selected one of the target cluster rectangular regions is the highest priority.

The second condition is that, if the rushing-out information is associated with each of selected ones of the target cluster rectangular regions corresponding to the respective pedestrians, the priority order of the pedestrians corresponding to the selected target cluster rectangular regions is determined based on the relationship between the location coordinates of the selected target cluster rectangular regions and the predicted travelling region of the vehicle V such that the priority order is the order defined based on their closer levels to the predicted travelling region of the vehicle V.

The third condition is that, if no rushing-out information is associated with the target cluster rectangular regions corresponding to the respective pedestrians, the priority order of the pedestrians corresponding to the target cluster rectangular regions is determined based on the relationship between the location coordinates of the respective target cluster rectangular regions and the predicted travelling region of the vehicle V such that the priority order is the order defined based on their closer levels to the predicted travelling region of the vehicle V.

Note that the processor 10 directly performs the operation in step S360 if a cluster rectangular region is only detected in step S140.

When the priority order is determined among the pedestrians in step S350, the processor 10 outputs, in step S360, the location coordinate and/or speed information of each of the pedestrians to at least one of the controlled objects 26 in accordance with the determined priority order in step S260, and thereafter terminates the target-object detection routine.

Otherwise, when no priority order is determined among the pedestrians, that is, the single pedestrian is detected in step S350, the processor 10 outputs the location coordinate and/or speed information of the pedestrian to at least one of the controlled objects 26 in accordance with the determined priority order in step S260, and thereafter terminates the target-object detection routine.

The at least one of the controlled objects 26 performs, if need arises, an operation to avoid a collision between the at least one pedestrian and the vehicle V, or an operation to reduce impacts based on a collision therebetween in accordance with the location coordinate and/or speed information of at least one pedestrian output from the processor 10.

Note that the speed information of a detected pedestrian can be obtained by the processor 10 based on the frame images. The information measured by the sensor 22 can be used as the speed information of a detected pedestrian.

When it is determined that the pedestrians corresponding to respective target cluster rectangular regions are each concluded not to show a pedestrian in step S330, the processor 10 terminates the target-object detection routine while skipping the operations in steps S350 and S360.

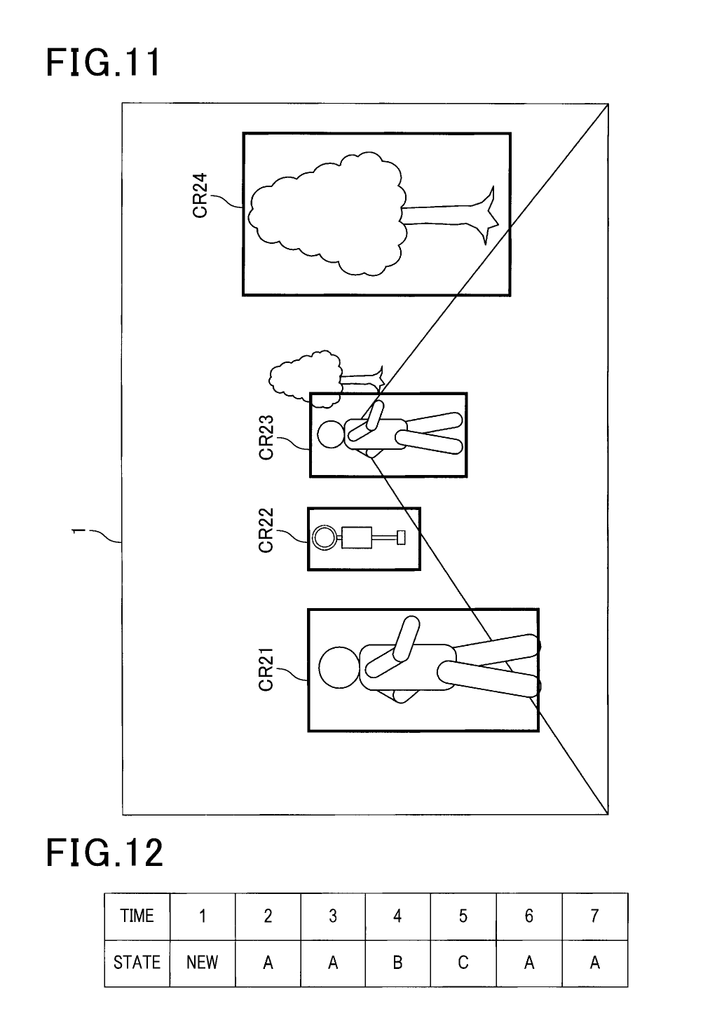

As illustrated in FIG. 11, if execution of the target-object detection routine results in four cluster rectangular regions CR21 to CR24 being detected from a frame image I, tracking of the four cluster rectangular regions CR21 to CR24 are carried out. Referring to FIG. 12, the tracking state of any one cluster rectangular region, i.e. a target cluster rectangular region, of the rectangular cluster regions CR21 to CR24 for example changes such that
1. The target rectangular cluster region becomes the new tracking state at time 1 when the target-object detection routine, which will be referred to as a first target-object detection routine, is carried out in response to first detection of the target cluster rectangular region
2. The target rectangular cluster region transitions to the tracking state A at time 2 when the second target-object detection routine is carried out.

Thereafter, each time a frame image is sent from the camera 21, the tracking state of the target cluster rectangular region transitions as illustrated in FIG. 12 (see time t3, t4, . . . ) depending on whether the target cluster rectangular region satisfies the corresponding transition condition.

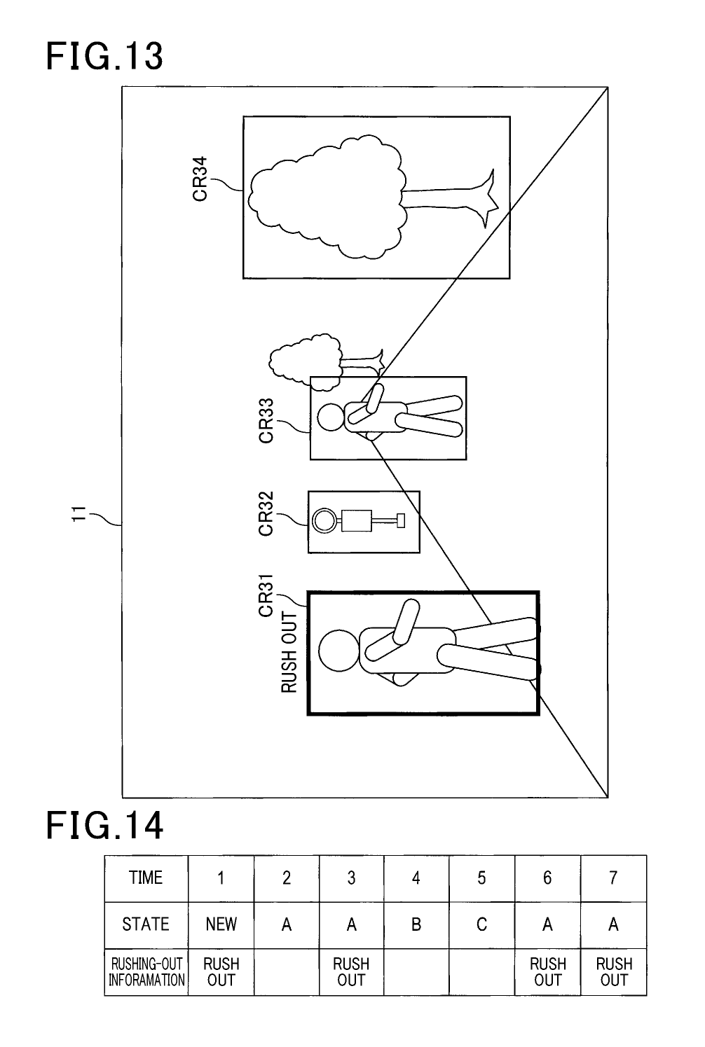

As illustrated in FIG. 13, it is assumed that execution of the target-object detection routine results in four cluster rectangular regions CR31 to CR34 being detected from a frame image I1, and rush-out information is associated with the cluster rectangular region CR31 in the four cluster rectangular regions CR31 to CR34. An example of the tracking state of the cluster rectangular region CR31 is illustrated in FIG. 14.

Referring to FIG. 14, when the target-object detection routine, which will be referred to as a first target-object detection routine, is carried out at time t1 in response to first detection of the target cluster rectangular region, the operation in step S220. The target-object detection routine at the time 1 changes the transition condition for transition of the tracking state of the cluster rectangular region CR1 and/or the pedestrian finalizing condition of the cluster rectangular region CR1. This results in
(1) The state transition determination being carried out based on the changed transition condition
(2) The pedestrian determination being carried out based on the changed pedestrian finalizing condition.

Similarly, the transition condition for transition of the tracking state of the cluster rectangular region CR1 and/or the pedestrian finalizing condition of the cluster rectangular region CR1 are changed at each of time 3 corresponding to a third detection routine, time 6 corresponding to a sixth detection routine, and time 7 corresponding to a seventh detection routine. For each of the times 3, 6, and 7, this results in
(1) The state transition determination being carried out based on the changed transition condition
(2) The pedestrian determination being carried out based on the changed pedestrian finalizing condition. For each of times 2, 4, and 5 corresponding to respective second, fourth, and fifth detection routines, the state transition determination is carried out without the transition condition being changed, and the pedestrian determination is carried out without the pedestrian finalizing condition being changed.

### Advantageous Effects Achieved by Embodiment

The object detection apparatus 1 described in detail above serves as an apparatus for detecting a specified type of objects, such as pedestrian around the vehicle V as target objects. The processor 10 of the object detection apparatus 1 repeatedly obtains information based on at least a location of at least one object candidate lying around the vehicle V, such as information based on the location and shape of the at least one object.

Each time the processor 10 obtains the information about the at least one object candidate, the processor 10 determines which of plural states that the information about the at least one object lies in based on predetermined state transition conditions; the plural states are previously defined based on correlations of the at least one object candidate with the target object, thus causing the at least one object candidate to transition among the plural states.

Then, the processor 10 determines whether the at least one object candidate is a target object based on transition information; the transition information representing how the state of the at least one object candidate has previously transitioned.

The above object detection apparatus 1 determines whether the at least one object candidate is a target object based on the transition information; the transition information representing how the information about the at least one object candidate has transitioned among the previously defined plural states. This enables the object detection apparatus 1 to detect target objects with higher accuracy as compared to the conventional structure that determines whether a detected object is a target object using a simple threshold.

The processor 10 of the object detection apparatus 1 obtains a parameter indicative of a continued period for which the information about the at least one object candidate has continued in a first state since the timing when the at least one object candidate transitioned to the first tracking state; the first state is one of the plural states. The processor 10 transitions the information about the at least one object candidate to a second state in the plural states when a value of the parameter reaches a predetermined transition determination threshold; the second state is other than the first state.

The above object detection apparatus 1 establishes the condition indicative of whether the value of the parameter reaches the predetermined transition determination threshold as one of the state transition conditions; the parameter represents a continued period for which the information about the at least one object candidate has continued in the first state since the timing when the at least one object candidate transitioned to the first state.

The processor 10 of the object detection apparatus 11 obtains the parameter indicative of the continued period for which the information about the at least one object candidate has continued in a specified state since the timing when the at least one object candidate transitioned to the specified state. The processor 10 uses the condition that the value of the parameter reaches the predetermined transition determination threshold as a determination condition. That is, the processor 10 determines that the at least one object candidate is a target object when determining that the value of the parameter reaches the predetermined transition determination threshold.

The object detection apparatus 1 enables the at least one object candidate to be reliably determined as a target object in accordance with the period for which the at least one object candidate has continued in a predetermined state.

The processor 10 of the object detection apparatus 1 obtains rushing-out information based on whether the at least one object candidate will rush out into a predicted travelling region of the vehicle. Then, the processor 10 changes the state transition conditions or the determination conditions when the rushing-out information represents that the at least one object candidate will rush out into the predicted travelling region of the vehicle.

That is, the object detection apparatus 1 is capable of changing, for example, the determination conditions to increase the probability of the at least one object being detected as the target object when the rushing-out information represents that the at least one object candidate will rush out into the predicted travelling region of the vehicle. This configuration enables the at least one object candidate, which will rush out into the predicted travelling region of the vehicle, to be immediately determined as a target object.

The camera 21 of the object detection apparatus 10 repeatedly captures a frame image around the vehicle V, and repeatedly sends the captured frame image to the processor 10. The processor 10 changes, on the currently sent frame image, a predetermined searching window to obtain an object candidate cluster in a plurality of candidate regions in the frame image; each of the plurality of candidate region has a feature pattern similar to feature patterns of the target object. The object candidate cluster represents a group of candidate regions associated with each other in the plurality of candidate regions. Then, the processor 10 obtains likelihood-relevant information as part of the information about the at least one object candidate; the likelihood-relevant information represents the likelihood of the object candidate cluster corresponding to the target object.

Each time when obtaining the likelihood-relevant information about the object candidate cluster, which is the information about the at least one object candidate, the processor 10 determines that the likelihood-relevant information about the object candidate cluster lies in any one of the plural states in accordance with the predetermined transition conditions, thus causing the object candidate cluster to transition among the plural states.

Each time when obtaining the likelihood-relevant information about the object candidate cluster, which is the information about the at least one object candidate, the processor 10 determines whether the object candidate cluster corresponds to a target object in accordance with the transition information indicative of how the state associated with the object candidate cluster has transitioned.

As described above, the object detection apparatus 1 is configured to
(1) Obtain an object candidate cluster in the plurality of candidate regions in a frame image; each of the plurality of candidate region has a feature pattern similar to feature patterns of the target object, and the object candidate cluster represents a group of candidate regions associated with each other in the plurality of candidate regions
(2) Obtain the likelihood-relevant information as part of the information about the at least one object candidate; the likelihood-relevant information represents the likelihood of the object candidate cluster corresponding to the target object
(3) Obtain the transition information indicative of how the state associated with the object candidate cluster has transitioned among the plural states in accordance with the likelihood-relevant information
(4) Determine whether the object candidate cluster corresponds to a target object in accordance with the transition information.

This enables the object detection apparatus 1 to detect target objects with still higher accuracy as compared to the conventional structure that determines whether a detected object is a target object using a simple threshold.

The processor 10 of the object detection apparatus 10 uses the number of candidate regions in the group as the object candidate cluster as part of the likelihood-relevant information. In addition, the processor 10 uses whether the number of candidate regions in the group as the object candidate cluster is higher than a predetermined threshold as part of the likelihood-relevant information.

The processor 10 of the object detection apparatus 10 obtains a score of each of the candidate regions in the group as the object candidate cluster; the score represents the similarity of each of the candidate regions with respect to the feature patterns of the target object. Then, the processor 10 uses at least one of the maximum value and average value of the scores of the respective candidate regions as part of the likelihood-relevant information. In addition, the processor 10 uses information indicative of whether at least one of the maximum value and average value of the scores is higher than a predetermined threshold as the state transition conditions.

Plural types of the feature patterns of the target object are stored in the respective dictionary files. Different reliability levels of target-object detection are set to the respective dictionary files, and the dictionary files are stored in the processor 10 of the object detection apparatus 1.

The processor 10 of the object detection apparatus 1 changes, on the currently sent frame image, the predetermined searching window to obtain a plurality of candidate regions, which are similar to feature patterns stored in any one of the dictionary files, in the currently sent frame image. Then, the processor 10 obtains, in the obtained plurality of candidate regions, an object candidate cluster representing a group of candidate regions associated with each other in the plurality of candidate regions.

Thereafter, the processor 10 of the object detection apparatus 10 obtains, as the likelihood-relevant information, information indicative of any one of the dictionary files being used to obtain the candidate regions grouped as the object candidate cluster. Then, the processor 10 obtains the transition information of the object candidate cluster among the plural states in accordance with the likelihood-relevant information.

The processor 10 of the object detection apparatus 1 changes, on the currently sent frame image, the predetermined searching window using any one of the plural searching methods to obtain a plurality of candidate regions, which are similar to feature patterns stored in any one of the dictionary files, in the currently sent frame image. The plural searching methods each represent how to scan the currently sent frame image by the searching window. Then, the processor 10 obtains, in the obtained plurality of candidate regions, an object candidate cluster representing a group of candidate regions associated with each other in the plurality of candidate regions.

Thereafter, the processor 10 of the object detection apparatus 10 obtains, as the likelihood-relevant information, information indicative of any one of the searching methods being used to obtain the candidate regions grouped as the object candidate cluster. Then, the processor 10 obtains the transition information of the object candidate cluster among the plural states in accordance with the likelihood-relevant information.

The above object detection apparatus 1 using the above likelihood-relevant information enables target objects to be detected with higher accuracy as compared to the conventional structure that determines whether a detected object is a target object using a simple threshold.

Assuming that the object candidate cluster is detected in plurality, the processor 10 determines whether each of the plurality of object candidate clusters is a target object. When determining that some of the plurality of object candidate clusters are each a target object, the processor 10 selects some of the plurality of object candidate clusters. Then, the processor 10 determines the priority order of the target objects corresponding to the respective selected object candidate clusters in accordance with the pieces of location information of the respective selected object candidate clusters.

For example, at least one of the controlled objects 26 installed in the vehicle V performs the operations with respect to the target objects in accordance with the priority order determined for the target objects. This results in at least one of the controlled objects 26 installed in the vehicle V efficiently and smoothly performing the operations with respect to the target objects as compared with a case that parallely performs the operations with respect to the target objects.

### Modifications

The present invention is not limited to the above present embodiment, but includes
(1) A modified embodiment in which a part of the configuration of the present embodiment is omitted within the scope of solving the above problem
(2) A modified embodiment in which the present embodiment and the modifications described later are preferably combined with each other
(3) Any considerable variations within the scope of the inventions identified only in the claims.

Reference numerals used in the present embodiment are used in the claims, but they are used to aide understanding of each claim of the invention. Therefore, the reference numerals do not intend to limit the scope of each claim.

The present embodiment is configured to detect pedestrians, which are an example of a specified type of objects, as target objects, but the present invention is not limited thereto. Specifically, the present embodiment can detect trees or vehicles, which are another example of a specified type of objects, as target objects.

Example of Correlations between Elements of Present Invention and Structure of Embodiment

For example, the operations in steps S110, S130, S140, and S145 in all the operations carried out by the processor 10 according to the present embodiment serve as, for example, an obtaining unit according to the present invention. For example, the operation in step S112 in all the operations carried out by the processor 10 according to the present embodiment serves as, for example, a rushing-out information obtaining unit according to the present invention.

For example, the operations in steps S150, S160, S170, S210, S220, S230, and S240 in all the operations carried out by the processor 10 according to the present embodiment serve as, for example, a state transition unit according to the present invention.

For example, the operation in step S260 in all the operations carried out by the processor 10 according to the present embodiment serves as, for example, a determiner according to the present invention.

For example, the operation in step S170 in all the operations carried out by the processor 10 according to the present embodiment serves as, for example, a parameter obtaining unit according to the present invention.

For example, the operation in step S140 in all the operations carried out by the processor 10 according to the present embodiment serves as, for example, a clustering unit according to the present invention. For example, the operation in step S145 in all the operations carried out by the processor 10 according to the present embodiment serves as, for example, a relevant information calculator.

For example, the operation in step S170 in all the operations carried out by the processor 10 according to the present embodiment serves as, for example, a continued-period obtaining means according to the present invention. For example, the operations in steps S210 and S220 in all the operations carried out by the processor 10 according to the present embodiment serve as, for example, an object transition means according to the present invention. For example, the operations in steps S260, S330, and S360 in all the operations carried out by the processor 10 according to the present embodiment serve as, for example, an output means according to the present invention.

Each of the first identifier, which represents the number of rectangular regions associated with a corresponding cluster rectangular region, the second identifier, which represents the maximum or average score in a corresponding cluster rectangular region, the third identifier, which represents a dictionary file having the highest reliability level, and the fourth identifier, which represents a searching method having the highest reliability level serves as, for example, likelihood-relevant information.

Reference Sings List

| | |
|---|---|
| 1 | Object detection apparatus |
| 10 | Processor |
| 11 | CPU |
| 12 | Memory |
| 21 | Camera |
| 22 | Sensor |
| 26 | Controlled object |

1. An object detection apparatus for detecting a specified type of objects around a vehicle as a target object, the object detection apparatus comprising:
an obtaining unit configured to repeatedly obtain information based on at least a location of at least one object candidate around the vehicle, the at least one object candidate being a candidate of the target object;
a state transition unit configured to:
determine which of plural states that the information about the at least one object lies in based on a predetermined state transition condition each time the information about the at least one object candidate is obtained, the plural states being previously defined based on correlations of the at least one object candidate with the target object; and
cause the information about the at least one object candidate to transition among the plural states; and
a determiner configured to determine whether the at least one object candidate is a target object based on transition information, the transition information representing how a state associated with the at least one object candidate has previously transitioned.

2. The object detection apparatus according to claim 1, wherein:
the state transition unit comprises a parameter obtaining unit configured to obtain a parameter indicative of a continued period for which the information about the at least one object candidate has continued in a first state since a timing when the at least one object candidate transitioned to the first state, the first state being one of plural states; and
the state transition unit is configured to cause the information about the at least one object candidate to transition to a second state in the plural states when a value of the parameter reaches a predetermined transition determination threshold, the second state being other than the first state.

3. The object detection apparatus according to claim 1, wherein:
the state transition unit comprises a parameter obtaining unit configured to obtain a parameter indicative of a continued period for which the information about the at least one object candidate has continued in a specified state since a timing when the at least one object candidate transitioned to the specified state, the specified state being one of plural tracking states; and
the determiner is configured to use a condition that a value of the parameter reaches a predetermined threshold as a determination condition to determine that the at least one object candidate is a target object when determining that the value of the parameter reaches the predetermined threshold.

4. The object detection apparatus according to claim 1, further comprising:
a rushing-out information obtaining unit configured to obtain rushing-out information based on whether the at least one object candidate will rush out into a predicted travelling region of the vehicle,
wherein the determiner is configured to change the state transition condition when the rushing-out information represents that the at least one object candidate will rush out into the predicted travelling region of the vehicle.

5. The object detection apparatus according to claim 1, further comprising:
an image capturing unit configured to repeatedly capture a frame image around the vehicle, and repeatedly send the captured frame image to the obtaining unit,
wherein:
the obtaining unit comprises:
a clustering unit configured to change, on the currently sent frame image, a predetermined searching window to obtain an object candidate cluster in a plurality of candidate regions in the frame image, each of the plurality of candidate region having a feature pattern similar to feature patterns of the target object, the object candidate cluster representing a group of candidate regions associated with each other in the plurality of candidate regions; and
a relevant information calculator configured to calculate likelihood-relevant information as part of the information about the at least one object candidate, the likelihood-relevant information representing a likelihood of the object candidate cluster corresponding to the target object;
the state transition unit is configured to determine that the likelihood-relevant information about the object candidate cluster lies in one of the plural states in accordance with the predetermined transition condition each time when the likelihood-relevant information about the object candidate cluster, which is the information about the at least one object candidate, is calculated, thus causing the object candidate cluster to transition among the plural states; and
the determiner is configured to determine whether the object candidate cluster corresponds to a target object in accordance with transition information, the transition information representing how the state associated with the object candidate cluster has transitioned.

6. The object detection apparatus according to claim 5, wherein:
the relevant information calculator is configured to calculate the number of the candidate regions in the group as the object candidate cluster as part of the likelihood-relevant information; and
the state transition unit is configured to use whether the number of the candidate regions in the group as the object candidate cluster is higher than a predetermined threshold as part of the likelihood-relevant information.

7. The object detection apparatus according to claim 5, wherein:
the relevant information calculator is configured to:
calculate a score of each of the candidate regions in the group as the object candidate cluster, the score representing a similarity of each of the candidate regions with respect to feature patterns of the target object; and
use at least one of a maximum value and an average value of the scores of the respective candidate regions as part of the likelihood-relevant information; and
the state transition unit is configured to use information indicative of whether at least one of the maximum value and average value of the scores is higher than a predetermined threshold as part of the state transition condition.

8. The object detection apparatus according to claim 5, wherein plural types of the feature patterns of the target object are stored in respective dictionary files, different reliability levels of target-object detection being set to the respective dictionary files, the object detection apparatus further comprising a storage storing the dictionary files, and wherein:
the clustering unit is configured to:
change, on the currently sent frame image, the predetermined searching window to obtain the plurality of candidate regions in the currently sent frame image, the plurality of candidate regions being similar to the feature patterns stored in any one of the dictionary files; and
obtain, in the obtained plurality of candidate regions, the object candidate cluster representing the group of candidate regions associated with each other in the plurality of candidate regions;
the relevant information calculator is configured to calculate, as part of the likelihood-relevant information, file information indicative of any one of the dictionary files being used to obtain the candidate regions grouped as the object candidate cluster; and
the state transition unit is configured to obtain the transition information of the object candidate cluster among the plural states in accordance with the obtained file information of the object candidate cluster.

9. The object detection apparatus according to claim 5, wherein:
the clustering unit is configured to:
change, on the currently sent frame image, the predetermined searching window using any one of plural searching methods to obtain the plurality of candidate regions in the currently sent frame image, the plurality of candidate regions being similar to the feature patterns of the target object, the plural searching methods each representing how to move the currently sent frame image by the searching window; and
obtain, in the obtained plurality of candidate regions, the object candidate cluster representing the group of candidate regions associated with each other in the plurality of candidate regions;
the relevant information calculator is configured to calculate, as part of the likelihood-relevant information, search information indicative of any one of the searching methods being used to obtain the candidate regions grouped as the object candidate cluster; and
the state transition unit is configured to obtain the transition information of the object candidate cluster among the plural states in accordance with the obtained search information of the object candidate cluster.

10. The object detection apparatus according to claim 5, wherein:
the object candidate cluster is detected in plurality;
the determiner is configured to:
determine whether each of the plurality of object candidate clusters is a target object;
select part of the plurality of object candidate clusters when determining that the part of the plurality of object candidate clusters are each a target object; and
determine a priority order of the target objects corresponding to the respective selected object candidate clusters in accordance with the information based on the location of each of the selected object candidate clusters.

11. A computer program product readable by a computer for detecting a specified type of objects lying around a vehicle as a target object, the computer program product being configured to cause a computer to execute:
a first step of repeatedly obtaining information based on at least a location of at least one object candidate lying around the vehicle, the at least one object candidate being a candidate of the target object;
a second step of:
determining that the information about the at least one object lies in which of plural states in accordance with a predetermined state transition condition each time the information about the at least one object candidate is obtained, the plural states being previously defined based on correlations of the at least one object candidate with the target object; and
causing the information about the at least one object candidate to transition among the plural states; and
a third step of determining whether the at least one object candidate is a target object based on transition information, the transition information representing how a state associated with the at least one object candidate has transitioned.

12. A method of detecting a specified type of objects lying around a vehicle as a target object, the method comprising:
a first step of repeatedly obtaining information based on at least a location of at least one object candidate lying around the vehicle, the at least one object candidate being a candidate of the target object;
a second step of:
determining that the information about the at least one object lies in which of plural states in accordance with a predetermined state transition condition each time the information about the at least one object candidate is obtained, the plural states being previously defined based on correlations of the at least one object candidate with the target object; and
causing the information about the at least one object candidate to transition among the plural states; and
a third step of determining whether the at least one object candidate is a target object based on transition information, the transition information representing how a state associated with the at least one object candidate has transitioned.
